(19) United States
(12) Patent Application Publication
(10) Pub. No.: US 2012/0086204 A1
(43) Pub. Date: Apr. 12, 2012

(54) SYSTEM AND METHOD FOR CONTROLLED HYDROELECTRIC POWER GENERATION

(75) Inventor: Daniel Ré, Les Agettes (Valais) (CH)

(73) Assignee: CLA-VAL CO., Costa Mesa, CA (US)

(21) Appl. No.: 13/269,111

(22) Filed: Oct. 7, 2011

Related U.S. Application Data
(60) Provisional application No. 61/391,975, filed on Oct. 11, 2010.

(51) Int. Cl. H02P 9/04

(52) U.S. Cl. 290/43

(57) ABSTRACT

A system for generating electricity in a water distribution network includes a hydroelectric generator in fluid communication with a pipeline or a valve of the network. A differential pressure control pilot limits differential pressure across the hydroelectric generator. A solenoid coupled to the differential control pilot controls water passage through the differential control pilot, and thus the operation of the hydroelectric generator. An electronic controller may be used to optimize power generated by the hydroelectric generator.

### BACKGROUND OF THE INVENTION

The present invention is generally directed to hydroelectric generators. More particularly, the present invention is directed to a system and method for generating electricity in a water distribution network in a controlled and optimized manner.

Fluid distribution networks are used in a variety of applications to distribute fluid, such as water, from a central reservoir to one or more remote locations where the fluid is available for use. A fluid distribution network is designed to provide the maximum amount of fluid at a pressure significantly higher than the highest design pressure of all the remote locations. Consequently, fluid-distribution networks typically include pressure-reducing valves to reduce the pressure and flow rate of the fluid before the fluid reaches the remote locations. For example, a typical water-distribution system used by a city to supply water for commercial and residential use includes one or more main water lines that convey water from a local reservoir or pump station to zones within the city.

Such fluid distribution networks often have sensors, components, lighting, etc. which require electrical power. In some cases, the electrical power is readily available from the city's or municipality's power grid which can be fed directly into underground vaults or chambers, or other locations where there are such pressure reducing valves, sensors, and other components. However, in other cases electricity is not as readily available.

In these instances, a solar panel may be used to generate electricity. However, such solar panels have drawbacks in that they are limited in their ability to generate power, such as during cloudy days or prolonged adverse weather conditions. Moreover, such solar panels need to be positioned above ground and in an area which can readily collect sunlight. Not only can placement be complicated, but there are concerns as to the solar panel being damaged, such as by vandalism or other means.

In still other instances, batteries are used to supply the power necessary for the sensors, electronic controllers, etc. However, batteries have a limited amount of electricity which can be provided to these components, and thus have a limited useful life. This requires that these sites be routinely visited and the batteries replaced. Moreover, in some instances, battery power alone is insufficient to provide the necessary electricity for all of the electrical components.

More recently, it has been realized that the reduction in fluid pressure throughout the fluid distribution network releases energy which can be advantageously used to generate electrical power.

For example, hydroelectric generators that are powered by the flow of fluid through a pipeline are known. U.S. Pat. No. 7,723,860 B2 is directed to a hydroelectric generator in which the turbine rotor is deployed within the fluid flow path of the pipeline and the turbine rotor whose rotation is affected by the flow of fluid through the pipeline also serves as the magnetic armature of the generator.

However, it has been found by the inventors that such systems have several disadvantages. One disadvantage is that the system is constantly running and producing electricity provided that there is a fluid flow through the pipeline, and thus the hydroelectric generator. Once the batteries or other power storage mechanisms have been completely filled to their maximum level, the excess power must be diverted, such as to heating coils or the like. Another disadvantage is that the hydroelectric generators themselves wear out prematurely due to their constant motion and action.

U.S. Pat. No. 6,824,347 B2 also discloses a hydroelectric power generating system. In this case, however, the turbine is disposed within a housing and parallel to the pipe of fluid flow, such that a controlled fluid flow is passed therethrough to generate power. Moreover, the power generated by the turbine can be independent of the pressure of the fluid discharged from the valve of the waterworks system. However, this system also has disadvantages in that it utilizes a flow-control circuit to sense the discharge flow from the valve outlet and in response regulate the flow of fluid that the valve outlet discharges. This is used to control the fluid flow and pressure through the turbine. However, the system encounters many of the same disadvantages as the '860 patent system in that excess electricity can be generated, and the turbine which is constantly in operation will wear out prematurely.

Accordingly, there is a continuing need for a system and method of hydro-power generation which is able to both regulate the rotational speed of the turbine impellor and start and stop the impellor rotation depending upon power levels and need. Moreover, there is a continuing need to optimize the power generated from hydroelectric generators within water distribution networks. The present invention fulfills these needs and provides other related advantages.

### SUMMARY OF THE INVENTION

The present invention resides in a system for generating electricity in a water distribution network. The system and method of the present invention is able to regulate the rotational speed of the turbine impellor, and start and stop the impellor rotation depending upon power levels and need. Moreover, the system and method of the present invention optimizes the power generated by the hydroelectric generator.

The system generally comprises a hydroelectric generator having a water inlet and a water outlet in fluid communication with a pipeline or a valve of a water distribution network. Typically, the hydroelectric generator is fluidly coupled to a valve of the water distribution network as a bypass, such that the inlet of the hydroelectric generator is in fluid communication with water upstream in the valve, and the outlet of the hydroelectric generator is in fluid communication with water downstream in the valve. Typically, a power storage device, such as a battery or a capacitor, is electrically connected to the hydroelectric generator.

A differential pressure control pilot limits the differential pressure across the inlet and the outlet of the hydroelectric generator. The differential pressure control pilot comprises a spring-biased hydroelectric diaphragm assembly for maintaining a differential pressure across the hydroelectric generator. The differential pressure control pilot may be disposed upstream or downstream the hydroelectric generator so as to be in fluid communication therewith. In one embodiment, the differential pressure control pilot and the hydroelectric generator are formed as a single component.

A solenoid may be coupled to the differential control pilot or hydroelectric generator for controlling water passage therethrough. An electronic controller is operably connected to the solenoid in order to selectively power on and off the solenoid.

The electric controller may also include an algorithm and electronic circuit for adjusting voltage, current and/or resistance to optimize the power generated from the hydroelectric generator. The algorithm and electronic circuit can determine the optimal voltage and current, and adjust these values such as by modifying resistance, in which the optimal amount of power is generated for the water flowing through the hydroelectric generator.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a hydroelectric generator and a differential pressure control pilot coupled to one another, and a schematic illustration of an electronic controller coupled to the generator and a power storage device and electrical components;

FIG. 2 is a cross-sectional view of the differential control pilot device illustrated in FIG. 1;

FIG. 3 is a diagrammatic illustration of optimization of power generated from the hydroelectric generator, in accordance with the present invention;

FIG. 4 is a graph illustrating voltage and power regulation in relation to differential pressure, in accordance with the present invention;

FIG. 5 is a diagrammatic view of a display screen illustrating various parameters tracked and adjusted in accordance with the present invention;

FIG. 6 is a perspective view of a unit housing components of the system of the present invention, fluidly coupled to a bypass of a valve of a water distribution network;

FIG. 7 is a perspective view of components of the present invention housed within the unit of FIG. 6;

FIG. 8 is a view similar to FIG. 7, but illustrating the use of multiple hydroelectric generators;

FIG. 9 is a perspective view of a device comprising a hydroelectric generator and a differential pressure control pilot and an electronic valve fluidly coupled to a valve of a water distribution network and electrically coupled to a storage device and electronic controller, in accordance with the present invention;

FIG. 10 is a cross-sectional view of the device of FIG. 9, electrically connected to a power control panel, power storage device, and electrical component;

FIG. 11 is a top cross-sectional view of the device of FIG. 9;

FIG. 12 is another side cross-sectional view of the device of FIG. 9; and

FIG. 13 is a cross-sectional view similar to FIG. 10, but with a flow path thereof altered.

### DETAILED DESCRIPTION OF THE PREFERRED EMBODIMENTS

The present invention is directed to a system and method for generating electricity in a controlled fluid system, such as a public water distribution network and the like. The system and method of the present invention are particularly useful in applications where a power source is desired but may not be practical. An example would be a need for power in a remote location where a means of supplying power from a power grid may not be possible or convenient. The present invention is intended as a means of generating power where the power can be used to control electronic components associated with a valve, as a power source for lighting in and around the area of the valve such as an underground vault or chamber, etc.

As will be more fully described herein, the present invention is directed to a system and method which generates electricity in a controlled manner utilizing a differential pressure control device in conjunction with a hydroelectric power generator. The present invention is used to control the rotational speed of the turbine of the hydroelectric generator, such as by altering or modifying the differential pressure through the hydroelectric generator and thus the flow of water through the hydroelectric generator. The power output of the electrical generator can be modified and optimized for a given flow rate through the hydroelectric generator. The generated power can be used to operate a variety of electrical devices and/or be stored in a storage device such as one or more batteries or storage capacitors or the like. The entire system can be used to electrically operate and/or monitor valve activity without the use of a local power supply.

The principles and operation of the hydroelectric generator system of the present invention may be better understood with reference to the drawings and the accompanying description. In the following detailed description of exemplary embodiments of the invention, reference is made to the accompanying drawings, which form a part hereof. The detailed description of the drawings illustrates specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention.

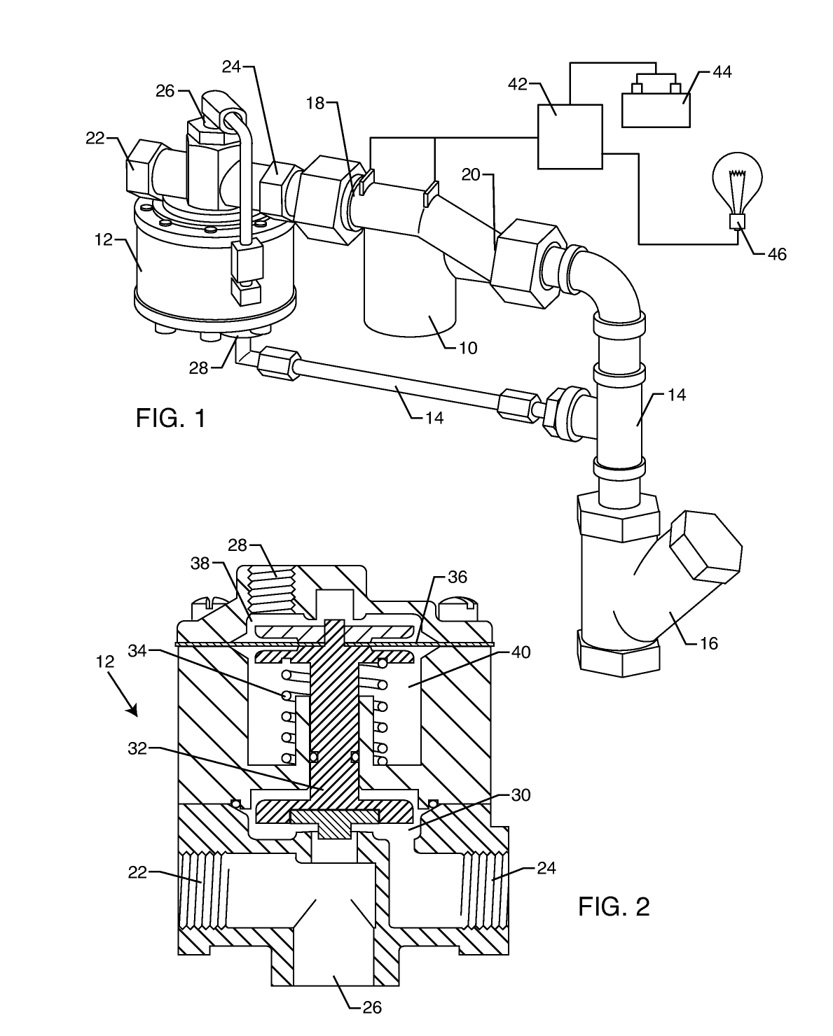

With reference now to FIG. 1, a hydroelectric power generator unit 10 is shown fluidly coupled to a differential pressure control pilot device 12. The hydroelectric power generator 10 and the differential control pilot device 12 are fluidly coupled to one another and disposed within a water distribution network, such as within a pipeline thereof or more typically coupled to a valve, such as by means of a bypass of typically a main valve, or a pressure reducing valve or other control-type valve. Illustrated in FIG. 1 are various pipes 14 and components, such as the Y-strainer 16 which could be used to fluidly couple the hydroelectric power generator 10 and the differential control pilot device 12 to the water distribution network, such as forming a bypass to a valve.

It will be understood that an inlet 18 of the hydroelectric power generator unit is in fluid communication with water upstream the valve while the outlet 20 of the generator is in fluid communication with water downstream the valve. In any event, the flow of water through the hydroelectric power generator rotates a turbine blade within the power generator, which is coupled to a generator that converts this rotational energy to electrical power. The greater the fluid flow or differential fluid pressure, the faster the turbine blade will rotate. However, the hydroelectric power generator will have a maximum electrical power generation limit at a given rotational speed. Thus, even if the turbine blade or impeller of the hydroelectric power generator rotates at a faster speed, additional electric power will not be generated by the hydroelectric power generator 10. As mentioned above, hydroelectric power generators operating at unnecessarily high speeds can damage the hydroelectric power generator, particularly over time and thus shorten the operating lifespan of the hydroelectric power generator.

In order to limit the differential fluid pressure across the hydroelectric power generator, or stated in other words the flow through the hydroelectric power generator 10, the differential control pilot device 12 is fluidly coupled to the hydroelectric power generator 10 and can be disposed either upstream or downstream of the hydroelectric power generator 10 to accomplish this.

FIG. 2 is a cross-sectional view of the differential control pilot device 12 illustrated in FIG. 1. For purposes of illustration and explanation, the differential control pilot device 12 illustrated in FIG. 2 has been rotated 180°, or flipped upside down, with respect to that illustrated in FIG. 1. As can be seen in FIG. 2, the differential control pilot device 12 includes a fluid inlet 22, a fluid outlet 24, as well as passageways 26 and 28 for introducing fluid into chambers of the device 12 and fluid communication with other components or pipelines of the system. It will be seen that there is a passageway 30 formed between the inlet 22 and outlet 24 of the device 12. A poppet 32 is disposed within the device 12 and travels so as to open and close the passageway 30. The poppet 32 is acted upon by spring 34 and diaphragm 36.

The position of the diaphragm 36 is influenced by the differential pressure between chambers 38 and 40. For example, when there is a sufficient fluid pressure in chamber 38 so as to overcome the bias of spring 34 as well as the pressure of chamber 40 (which may be atmospheric pressure), the poppet 32 will be moved downwardly so as to increasingly close the passageway 30. The tension on the spring 34 can be adjusted such that the poppet 32 will be more easily moved into the passageway 30 so as to increasingly close the passageway 30, or present increased resistance of the movement of the poppet 32 into the passageway 30. Thus, the selection of the spring or the tensioning of the spring 34 can be used to set an upper fluid flow or differential pressure limit such that a maximum fluid flow or differential pressure is passed through the differential control pilot device 12, and thus to the hydroelectric power generator 10, such that the fluid flow or differential pressure across the hydroelectric power generator 10 does not exceed a preselected level. Typically, this preselected level corresponds with an upper rotational speed limit of the hydroelectric power generator, above which additional electricity or power is not generated. In this manner, the hydroelectric power generator 10 is operated up to its maximum rotational speed potential, without unnecessary increased rotational speed which can damage the internal parts thereof and shorten the useful life of the hydroelectric power generator 10.

With reference again to FIG. 1, the differential pressure across the valve and through the water distribution network typically varies during a 24-hour a day cycle due to consumption variations, system head loss, etc. This will result in a differential pressure across the differential control pilot valve device 12, and thus the hydroelectric turbine power generator 10. Thus, there will be times when the differential pressure, or fluid flow, across the hydroelectric power generator 10 will be less than that required to rotate the turbine of the hydroelectric power generator 10 at a sufficient speed for maximum power generation. For example, for a particular differential pressure, the turbine of the hydroelectric power generator will have a given rotations-per-minute (RPM) characteristic curve of current (I) versus volts (V). Thus, as an example, a pressure differential of 7 m or greater may rotate the turbine of the hydroelectric generator 10 at its maximum rotational speed or maximum power generation capability. However, a pressure differential at 6 m or 5 m or less will result in the RPM of the turbine being lessened, resulting in less power generated.

When the turbine blade is spinning, it is producing a given unconditioned voltage that may not necessarily produce the maximum possible power for the given turbine RPM. In order to maximize the power generated by the system of the present invention, the system incorporates an electronic controller 42 which is electrically connected to the hydroelectric power generator 10 and which feeds the optimized power to the battery, capacitor, or other electrical storage device 44 and/or the electrical component(s) 46 of the valve or other components of the water distribution network. It will also be understood by those skilled in the art that the electrical components 46 may receive their electricity and power directly from the battery or other power storage device 44. However, instead of directing the power generated from the hydroelectric power generator 10 directly to the rechargeable battery or other power storage device 44, the power is passed through the electronic controller 42 for optimization.

The electronic controller 42 includes an electronic circuit and algorithm which vary the electrical operating point of the system to deliver maximum available power. This peak power point converter or maximum power point tracker system is a high efficiency electricity converter that presents an optimal electrical load and produces a voltage suitable for that load. In accordance with the invention, the algorithm determines an operating point where the values of the current and the voltage result in a maximum power output. These values correspond to a particular load resistance, which is equal to voltage divided by current, as specified by Ohm's Law. The maximum power point tracker of the present invention utilizes a control circuit and software logic to search for this point at any given turbine speed of the hydroelectric power generator 10 and pressure differential and thus allow the converter circuit to extract the maximum power available from the system.

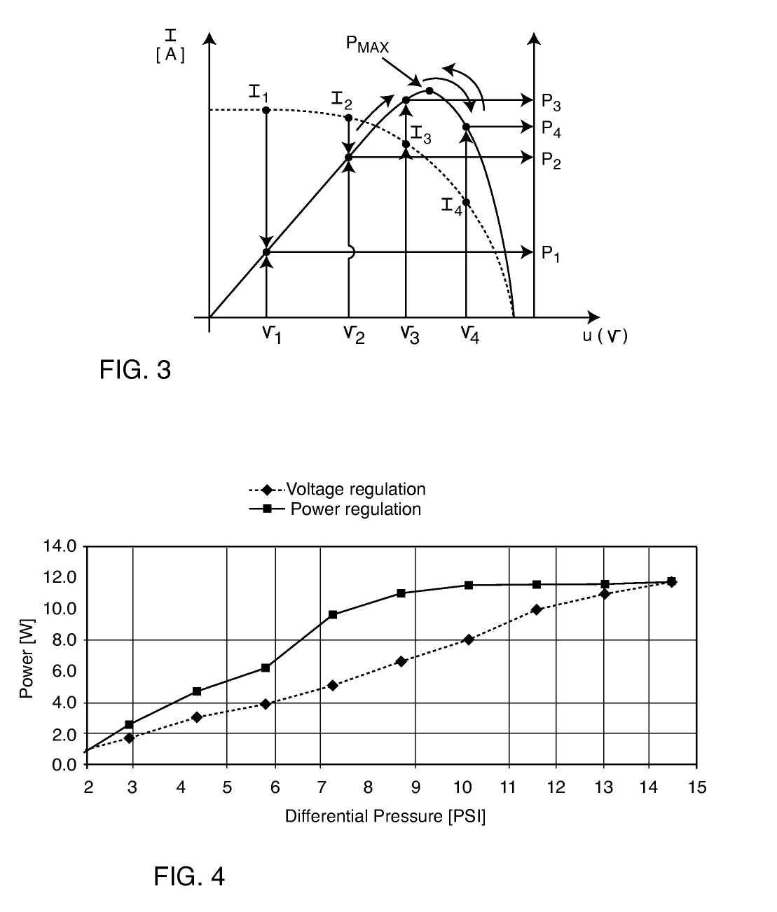

With reference now to FIG. 3, the maximum power point tracker circuit and algorithm of the present invention analyzes the voltage to amps power output of the power generator 10 and determines the maximum power by adjusting (stepping up or stepping down) the voltage output. It continues to go through this process until the maximum power output value is achieved. At points below the maximum differential pressure allowed by the differential control pilot device 12, the power generated by the hydroelectric power generator 10 is not maximized. The electronic controller, by means of circuitry and an algorithm, optimizes the output of the system.

As shown in FIG. 3, for a given current level I₁ and voltage V₁, a given power P₁ is generated. Thus, the V₁ voltage produced by the differential pressure supplied by the system, a starting resistance or load and generating power results in point P₁ power output. The control program or circuit of the present invention adjusts the voltage, such as by increasing or decreasing the resistance or load, so as to create a different voltage V₂, the resulting voltage V₂ and current I₂ yield a power output P₂, which is greater than P₁. The voltage is then adjusted again, such as by increasing the resistance or load, such that the hydroelectric power generator is forced to adjust the output voltage to V₃, and when calculating the new voltage with the current I₃ yields a greater power output P₃, as illustrated in FIG. 3. The electronic circuit and algorithm continues this process of adjusting the voltage, by stepping up or stepping down the voltage output, until a lower power output is achieved.

For example, with continuing reference to FIG. 3, new adjusted voltage V₄ is created, such as by adjusting the resistance or load of the circuit, resulting in a lower current I₄, which yields a power output P₄, which is in fact lower than output P₃. Thus, between voltages V₃ and V₄ is the power output maximum Pₘₐₓ. The system of the present invention can then adjust the voltage by stepping up or stepping down the voltage output, such as by changing the resistance or load, until the Pₘₐₓ is achieved, or use power output P₃, which is greater than P₁, P₂, and P₄. With the appropriate analysis and conditioning, the Pₘₐₓ, or the maximum power output, of the system at any given rotational speed of the hydroelectric power generator 10, due to a given pressure differential across the hydroelectric power generator 10, can be determined and output to the battery 44 or electronic devices 46 needing power.

With reference now to FIG. 4, a graph showing the output power in relation to the differential pressure in pounds per square inch (PSI) is shown. It can be seen that using the maximum power point tracker circuit and algorithm of the present invention by regulating the voltage, and thus the output power, yields an output power which is optimized for a given differential pressure or rotational speed of the hydroelectric power generator 10. Of course, when the hydroelectric power generator 10 is rotating at its maximum speed, due to the flow or maximum differential pressure across the hydroelectric power generator 10, the maximum power point converter system of the present invention can no longer optimize power output from the hydroelectric power generator 10. However, at fluid flows or differential pressures less than maximum, the power converter system of the present invention can convert the input voltage to the electronic controller 42 and maximize it into usable power or charge current. The obtained maximum power output (Pₘₐₓ) from the hydroelectric power generator turbine 10 is converted into a maximum loading charge (in amps or milliamps) to the battery or other storage device 44 by dividing the Pₘₐₓ by the battery voltage.

The maximum power point tracker algorithm and circuit of the electronic controller can also be used to obviate the need for an electrical load diverter device, such as a heating coil or the like. The algorithm and electronic circuit can adjust the load or resistance to the extent where electrical power is not passed through the electronic controller to the power storage device 44, such as when the power storage device 44 is at full capacity.

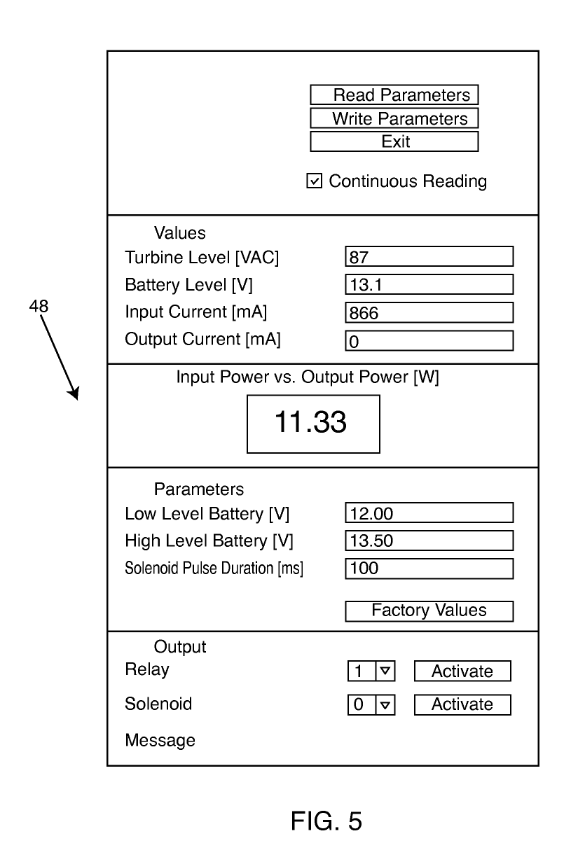

With reference now to FIG. 5, a display screen for programming and managing the parameters of the system, including input power, output power, battery management, etc. is shown. When the battery or other power storage device 44 reaches a predetermined low threshold, charging power can be supplied from the hydroelectric power generator 10 until sufficient electrical energy is supplied so as to refresh the power storage device to the desired high level. Through the display screen 48, various parameters and values of the system can be set, monitored or adjusted. For example, the turbine level, battery level, input current, output current, input power versus output power, and other parameters can be viewed and in some cases adjusted as needed.

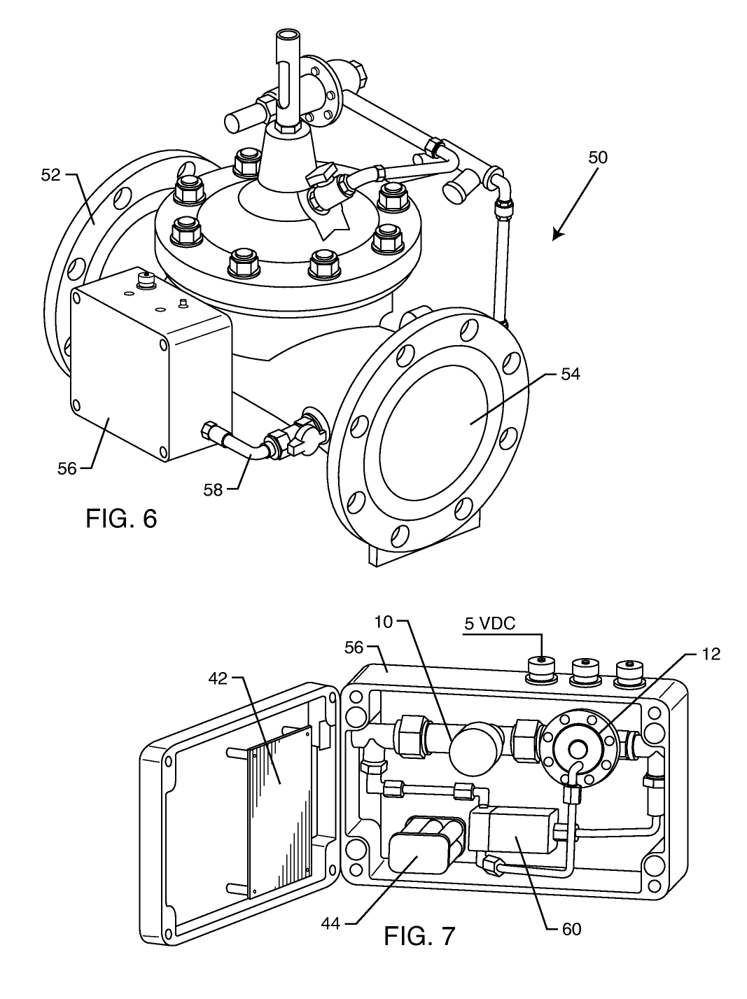

With reference now to FIGS. 6 and 7, a valve 50 which is typical of a main valve of a water distribution network is shown. The valve 50 includes an upstream inlet 52 and a downstream outlet 54. The valve 50 is used to reduce the pressure of the water stream upstream the valve 50 as compared to downstream the valve 50. Such valves 50 are well known in the art.

FIG. 6 illustrates a housing 56 which houses individual components of the invention, as will be described herein, and which is plumbed, such as by piping 58 so as to be in fluid communication with the valve 50, typically by means of bypass ports of the valve 50. This provides a parallel fluid path from upstream or at the inlet of the valve 50 to downstream or at the outlet 54 of the valve 50.

With reference now to FIG. 7, the housing 56 houses various components of the system, including a hydroelectric power generator 10, a differential control pilot device 12, an electronic controller 42 and power storage device 44, such as rechargeable batteries. Although not illustrated, it will be understood that the electronic controller 42 and power storage device 44 are electrically coupled to one another and/or the hydroelectric power generator 10. It will also be understood that the electronic controller 42 can have the electronic circuitry and maximum power point tracker algorithm as described above so as to optimize the output power of the hydroelectric power generator 10, even at pressure differentials or rotational speeds below maximum.

As described above, a drawback of many prior art hydroelectric generating systems for water distribution networks is that water is constantly flowing through the hydroelectric power generator, causing electricity to be generated. However, when the associated electronic devices are not powered and the battery or other power storage device is full, this electricity and power must be diverted and dissipated, such as through a diversion load which may be a heating coil or the like. Aside from adding complexity and cost to the system, the constant operation of the hydroelectric power generator shortens its lifespan.

Thus, in accordance with the present invention, an electronically actuatable switch or valve, typically in the form of a solenoid 60, is incorporated into the system. As can be seen in FIG. 7, the solenoid 60 is fluidly coupled to the hydroelectric power generator 10 and/or the differential control pilot device 12. The electronic controller 42 can be used to selectively power the solenoid 60 such that fluid does not flow through the differential control pilot device 12 or the hydroelectric power generator 10. This would be the case, for example, when the power storage device 44 is at full capacity or at a predetermined high level. The electronic controller 42 can then be used to remove power or otherwise switch the solenoid 60 so as to enable the flow of water through the differential control pilot device 12 and/or hydroelectric power generator 10 so as to again create electrical power for charging the power storage device 44 and operating the various electrical components associated with the water distribution network which receive power from the present invention.

With reference again to FIG. 5, the various values and parameters can be set by programming such into the microprocessors or other controllers of the electronic controller 42. Thus, for example, a parameter may be set dictating a high level battery charge or voltage, illustrated at 13.50 volts in FIG. 5. In this condition, the solenoid 60 is activated so as to prevent fluid flow through the hydroelectric power generator 10, such that electrical power is not generated by the hydroelectric power generator 10. However, when the battery level becomes low, illustrated as a 12.0 volt set parameter in FIG. 5, the solenoid will automatically be activated once again (or deactivated) such that the water flows through the hydroelectric power generator 10, thus providing electrical power to the system and the battery storage device 44.

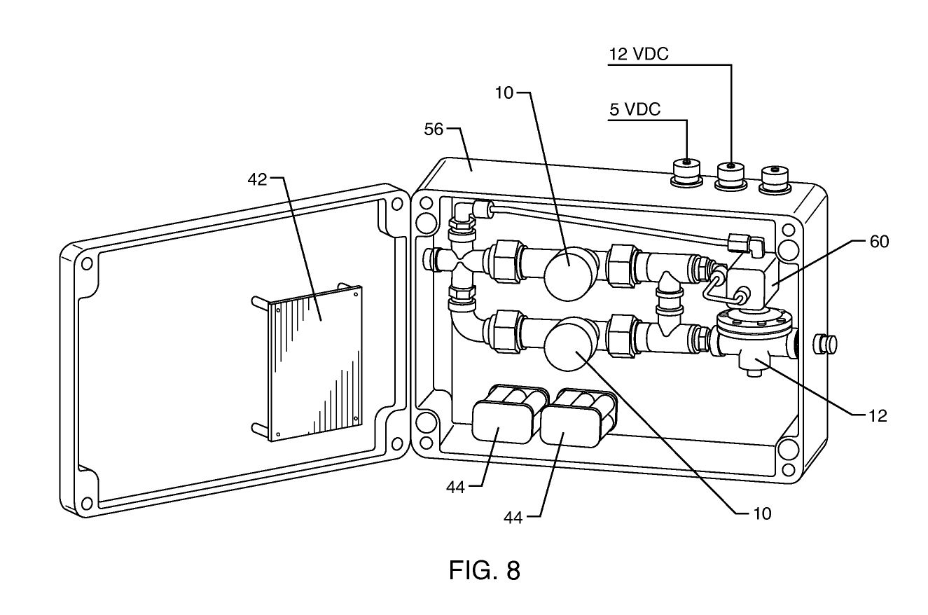

As illustrated in FIGS. 7 and 8, the solenoid 60 may be coupled or otherwise in fluid communication with the differential control pilot device 12 such that the activation or deactivation of the solenoid 60 opens or closes fluid flow pathways within the differential control pilot device 12 so as to cause the poppet 32 thereof to move and either open or close the fluid flow pathway to the hydroelectric power generator 10. When the poppet 32 is closed, the fluid flow pathway 30 is also closed, causing fluid to no longer flow through the hydroelectric power generator 10, and thus the hydroelectric power generator turbine to not rotate and the generator thereof to not create electricity. However, by activating or deactivating the solenoid 60, fluid pathways in the differential control pilot device 12 can be altered such that the combined spring 34 tension and fluid chamber 38 pressure cause the poppet 32 to open, allowing water through the passageway 30 and thus through the hydroelectric power generator 10, causing it to generate electrical power.

With reference now to FIG. 8, the amount of electricity generated by the system of the present invention can be modified by incorporating multiple hydroelectric power generator devices 10, which for example, can increase the voltage generated from five volts to twelve volts when utilizing two of the hydroelectric power generators 10 instead of only one. As illustrated in FIG. 8, a single differential control pilot device 12 and solenoid 60 serve to control the differential pressure and fluid flow through the hydroelectric power generators 10, although a dedicated differential control pilot device 12 and solenoid 60 could be associated with each hydroelectric power generator 10. Of course, different sized and rated hydroelectric power generators could be used to control the amount of voltage and power generated by a single device instead of incorporating multiple devices.

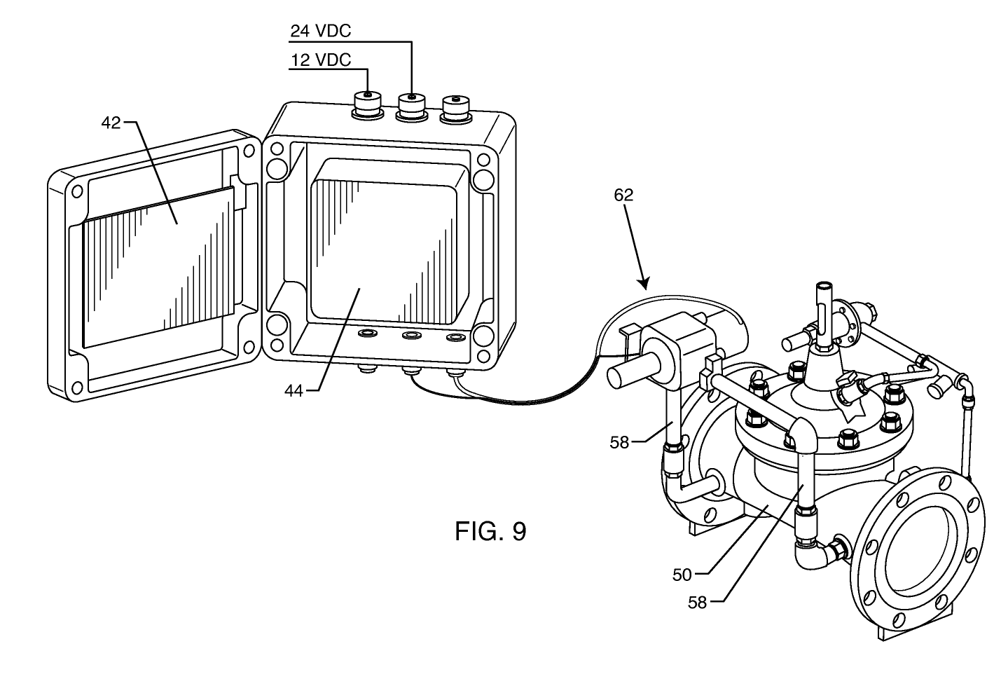

Instead of having the hydroelectric power generator 10, differential control pilot device 12, and solenoid 60 be separate components fluidly coupled to one another via appropriate piping and connections, these components 10, 12 and 60 can be incorporated into a single unit 62, as illustrated in FIG. 9. The unit 62 is in fluid communication with the valve 50, such as by means of pipes 58 which are coupled to bypass ports of the valve 50, so as to create a parallel fluid pathway across the valve 50. The unit 62 is electrically connected to an electronic controller 42 and electrical storage device 44 so as to send electrical power from the hydroelectric power generator portion of the unit 62 and so as to receive electrical power to the solenoid portion thereof, as will be further described herein.

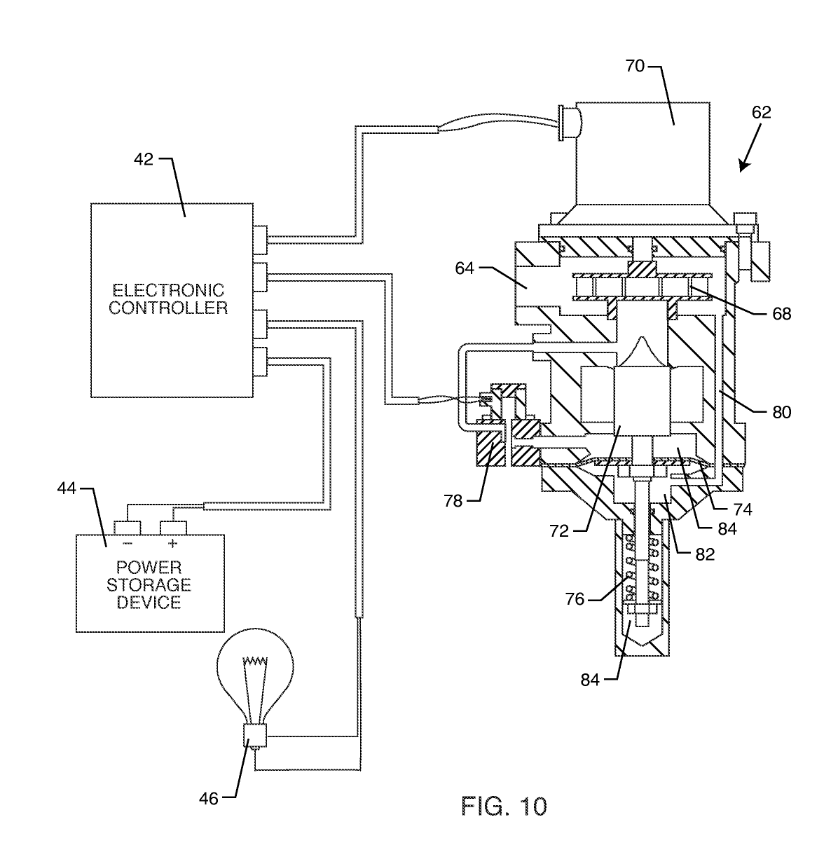

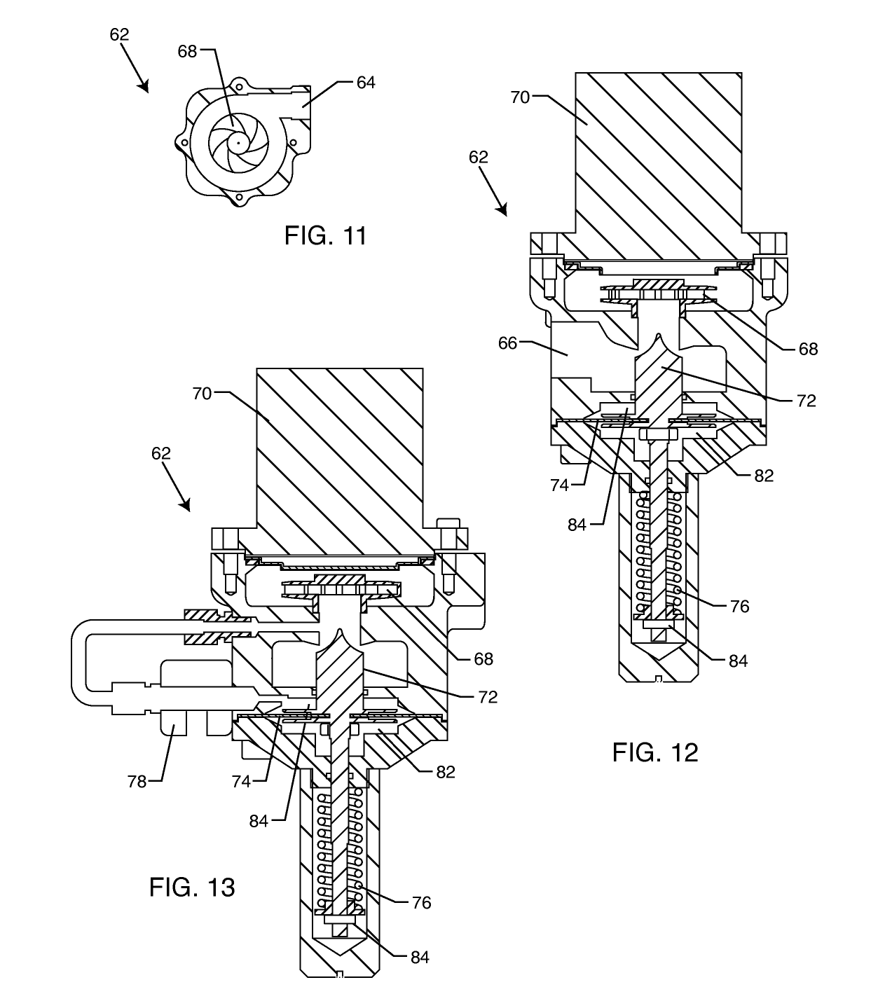

With reference now to FIGS. 10 and 12, the unit 62 includes a water inlet 64 and a water outlet 66 which form a fluid pathway past a turbine or impeller 68 which is coupled to a generator 70 such that as the turbine 68 is rotated the generator 70 creates electrical power which is passed to the power control panel or electronic controller 42 for power optimization, as detailed above in connection with FIGS. 3 and 4.

The unit 62 also includes a turbine regulator valve in the form of a poppet 72 which is coupled to a diaphragm 74 and biased by means of spring 76. The poppet 72, diaphragm 74 and spring 76 serve similar functions as the differential control pilot device 12 components in opening and closing a fluid passageway between the inlet 64 and outlet 66 of the unit 62, so as to allow fluid to flow therethrough and past the turbine 68, or so as to block the passageway and prevent fluid flow past the turbine 68, wherein the turbine 68 will not rotate and the generator 70 not create electrical power when the passageway is completely blocked.

Whether the poppet 72 is under the influence of the bias of the spring 76, so as to open the fluid flow passageway, as illustrated in FIGS. 12 and 13, or under the influence and moved by the pressure exerted on the diaphragm 74 so as to close the fluid flow passageway, as illustrated in FIG. 10, is controlled by means of an electrically actuated valve such as a solenoid 78.

When the solenoid is activated or deactivated, such as illustrated in FIG. 10, water entering inlet 64 passes through passageway 80 and into chamber 82, which pressure builds and impinges upon diaphragm 74, causing the diaphragm to move and thus the poppet 72 to move against the bias of spring 76 and close the poppet 72, preventing fluid flow from inlet 64 to outlet 66. The lack of fluid flow due to the closed differential control pilot internal to the unit 62 results in the turbine 68 not rotating due to the lack of fluid flow thereover. Of course, in such a situation electrical power is not created by the generator 70. The activation or deactivation of the solenoid 78 to the position illustrated in FIG. 10 would be by means of the electronic controller 42, which would have determined that the power storage device 44 was above a preselected threshold and that no additional electrical power needed to be generated at that time.

With reference now to FIGS. 12 and 13, however, in the event that electrical power needed to be generated, such as if the power storage device 44 fell below a predetermined threshold and/or electrical devices 46 associated with the system were drawing power, then the electronic controller 42 would activate or deactivate the solenoid 78 to the other position illustrated in FIG. 13 such that the water would flow from the inlet 64 and through the unit 62 to the outlet 66 such that the water pressure in chamber 82 would be diminished and the poppet 72 would be biased by means of spring 76 into the open position, as illustrated in FIGS. 12 and 13, such that the flow of water past the turbine 68 would cause the turbine 68 to rotate and the electrical generator 70 to create electrical power, such as for replenishing the power storage device 44, powering the electrical components 46 and the like.

Rotational speed of the turbine 68 is maintained or limited by controlling or limiting the pressure drop through the rotating turbine or impeller 68. Pressure drop or fluid flow is controlled by varying the opening of the turbine regulating valve or poppet 72. As described above, the opening flow area through the poppet 72 is controlled by a combination of spring 76 forces and hydraulic forces acting on opposing sides of the regulating valve diaphragm 74. An increase in pressure in chamber 82 with respect to chamber 84 will cause the diaphragm to move into chamber 84, and thus move the poppet against the bias of spring 76 into a closed position. This will increasingly close the fluid passageway between the inlet 64 and the outlet 66, and thus the flow or pressure differential therebetween so as to decrease the rotational speed of the turbine 68, or in the completely closed position cause the turbine 68 to cease rotating completely. However, as the pressure in chamber 84 increases or the pressure in chamber 82 decreases, the force and bias of spring 76 pulls the poppet 72 and opens the fluid flow passageway between the inlet 64 and the outlet 66, as illustrated in FIGS. 12 and 13, increasing the pressure differential or fluid flow through the unit 62 and causing the turbine 68 to rotate at an increasing speed as the poppet 72 is moved into an increasingly open position. A two-position, three-way solenoid valve 78, as illustrated in FIGS. 10 and 13, is used to alter the fluid pathway, and thus the fluid pressure acting upon the regulator diaphragm 74, and thus the regulator poppet 72 so as to open or close the fluid flow between the inlet 64 and the outlet 66 of the unit 62 and thus adjust the rotational speed of the turbine 68 or cause the turbine 68 to cease rotating.

In this manner, predetermined thresholds and parameters can be set by means of the electronic controller in order to automatically activate or deactivate the solenoid 78 and so as to selectively generate power or not generate power by the unit 62. When the power storage device 44 is at a sufficiently high and preselected threshold of charged and storage capacity, then the solenoid 78 can be activated or deactivated such that the unit 62 does not generate additional electricity. Those skilled in the art will appreciate this obviates the need for any diversion load device, such as heating coil. Moreover, this prolongs the expected operating life of the unit 62, and particularly the turbine 68 and generator 70. Moreover, rotational speed of the turbine 68, even when the solenoid is activated or deactivated 78 so as to create a fluid flow through the turbine 68, is limited by limiting the pressure drop through the rotating impeller by means of and interaction between the poppet 72, diaphragm 74 and spring 76, as described above. The upper limit of the pressure drop or fluid flow through the unit 62 can be controlled by adjusting the tension of the spring 76, such as by tightening or loosening a nut 84 which compresses or decompresses the spring 76.

Although several embodiments have been described in detail for purposes of illustration, various modifications may be made without departing from the scope and spirit of the invention. Accordingly, the invention is not to be limited, except as by the appended claims.

What is claimed is:

1. A system for generating electricity in a water distribution network, the system comprising:
a hydroelectric generator having a water inlet and a water outlet in fluid communication with a pipeline or a valve of a water distribution network;
a differential pressure control pilot for limiting differential pressure across the inlet and the outlet of the hydroelectric generator; and
an electrically actuatable valve for controlling water passage through the hydroelectric generator.

2. The system of claim 1, wherein the hydroelectric generator is fluidly coupled by a bypass to the valve of the water distribution network.

3. The system of claim 2, wherein the inlet of the hydroelectric generator is in fluid communication with water upstream the valve and the outlet of the hydroelectric generator is in fluid communication with water downstream the valve.

4. The system of claim 1, including an electronic controller operably connected to the electrically actuatable valve for automatically powering the electrically actuatable valve.

5. The system of claim 1, including a power storage device electrically connected to the hydroelectric generator.

6. The system of claim 5, wherein the power storage device comprises a battery or a capacitor.

7. The system of claim 1, including an electronic controller coupled to the hydroelectric generator for optimizing the power generated by the system.

8. The system of claim 7, wherein the electronic controller includes an algorithm and electronic circuit for adjusting voltage, current and/or resistance to optimize power generated by the hydroelectric generator.

9. The system of claim 1, wherein the differential pressure control pilot includes a spring biased hydraulic diaphragm assembly for maintaining a differential pressure across the hydroelectric generator.

10. The system of claim 9, wherein the differential pressure control pilot is disposed upstream or downstream the hydroelectric generator and in fluid communication with the hydroelectric generator.

11. The system of claim 9, wherein the differential pressure control pilot and the hydroelectric generator are formed as a single component.

12. A system for generating electricity in a water distribution network, the system comprising:
a hydroelectric generator having a water inlet and a water outlet in fluid communication with a pipeline or a valve of a water distribution network;
a differential pressure control pilot including a spring biased hydraulic diaphragm assembly for maintaining a differential pressure across the hydroelectric generator; and
an electronic controller coupled to the hydroelectric generator, the electronic controller including an algorithm and electronic circuit for adjusting voltage, current and/or resistance to optimize power generated by the hydroelectric generator.

13. The system of claim 12, wherein the hydroelectric generator is fluidly coupled by a bypass to the valve of the water distribution network.

14. The system of claim 13, wherein the inlet of the hydroelectric generator is in fluid communication with water upstream the valve and the outlet of the hydroelectric generator is in fluid communication with water downstream the valve.

15. The system of claim 12, including an electrically actuatable valve operably coupled to the electronic controller and the hydroelectric generator for controlling water passage through the hydroelectric generator.

16. The system of claim 12, including a power storage device electrically connected to the hydroelectric generator.

17. The system of claim 16, wherein the power storage device comprises a battery or a capacitor.

18. The system of claim 12, wherein the differential pressure control pilot is disposed upstream or downstream the hydroelectric generator and in fluid communication with the hydroelectric generator.

19. The system of claim 12, wherein the differential pressure control pilot and the hydroelectric generator are formed as a single component.

20. A system for generating electricity in a water distribution network, the system comprising:
a hydroelectric generator having a water inlet and a water outlet in fluid communication with a valve of a water distribution network;
a differential pressure control pilot including a spring biased hydraulic diaphragm assembly in fluid communication with the hydroelectric generator for maintaining a differential pressure across the hydroelectric generator;
a solenoid for controlling water passage through the hydroelectric generator; and
an electronic controller coupled to the hydroelectric generator, the electronic controller including an algorithm and electronic circuit for adjusting voltage, current and/or resistance to optimize power generated by the hydroelectric generator.

21. The system of claim 20, including a power storage device electrically connected to the hydroelectric generator.

22. The system of claim 21, wherein the power storage device comprises a battery or a capacitor.

23. The system of claim 20, wherein the differential pressure control pilot and the hydroelectric generator are formed as a single component.

24. The system of claim 20, wherein the hydroelectric generator is in fluid communication with the valve of a water distribution network by means of a bypass conduit of the valve.
